(19) United States
(12) Patent Application Publication
(10) Pub. No.: US 2007/0124766 A1
(43) Pub. Date: May 31, 2007

(54) Video synthesizer

(75) Inventors: Sandeep Kumar Relan, Bangalore (IN); Brajabandhu Mishra, Orissa (IN); Rajendra Kumar Khare, Bangalore (IN)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 11/402,057

(22) Filed: Apr. 12, 2006

Related U.S. Application Data
(60) Provisional application No. 60/740,651, filed on Nov. 30, 2005.

(51) Int. Cl. H04N 5/445

(52) U.S. Cl. 725/38

(57) ABSTRACT

A video processing system receives a user input, retrieves a video element, constructs a processed video element from the video element using the user input and delivers the processed video element for display. The user input identifies one or more portions of the video element and/or objects from the video element. The user input also identifies one or more visual effects. The video processing system applies the identified one or more visual effects to the identified portions and/or objects from the video element. Thus a processed video element is generated. In one embodiment, the video element is selected from multiple available video elements by a user using a video guide. The video processing system has a storage system for storing multiple video elements and a list of visual effects.

### BACKGROUND OF THE INVENTION

1. Field of the Invention

Various aspects of the present invention relate to customizing video displayed in a viewing system based on user input through interaction with the viewing system.

2. Description of the Related Art

Professional and amateur video editing tools are available in market. These tools are pieces of software that convert a video file in one format to another format. For example, these video editing tools may typically convert audio video interleave (avi) files to VCD/DVD compliant mpeg files and vice versa. These can cut large avi and mpeg files into smaller video clips and join several avi files to a large avi file and/or a mpeg file and/or a DVD compliant mpeg file. A large file can be trimmed into a smaller file by time or by selection (such as selection of frames). Images from a video file can be extracted to some particular formats. These video editing tools offer a few video effects such as flip rotate, soften, sharpen, to be applied to the entire video file. A user is constrained to select from the few video effects. The user is left with no option to apply video effect to only a portion of the video file.

Studios have some specialized equipments and software that mix videos from two or more sources in real time, add motion graphics and several three-dimensional video effects, titles and captions to create a flawless professional video. Such software is expensive and allow for inserting, overwriting or replacing clips into the video. These offer a large number of transitions, filters and effects to choose from. However it requires mastery of video editing skills to operate these specialized equipment and software. These are not suitable for kids and for nonprofessional users. Again, these equipment and software are expensive.

Video editing systems are available in the market that combine two or more video sources in a variety of ways into a single video feed. These systems can switch between sources with simple cuts or create transitions such as dissolves, wipes, flips and zooming effects. Such video editing systems are typically used to compose a single video feed and the user is again forced to choose from a limited number of alternatives.

### DESCRIPTION OF THE DRAWINGS

For the present invention to be easily understood and readily practiced, various embodiments will now be described, for purposes of illustration and not limitation, in conjunction with the following figures:

FIG. 1 is a schematic block diagram illustrating interaction between a video processing system and a viewing system, in accordance with the present invention;

FIG. 2 is a schematic block diagram illustrating an interaction between a video processing system, a viewing system and a video sourcing system;

FIG. 3 is a schematic block diagram illustrating an embodiment of the video processing system of FIG. 2;

FIG. 4 is a schematic block diagram illustrating another embodiment of the video processing system of FIG. 2;

FIG. 5 is a schematic block diagram illustrating yet another embodiment of the video processing system of FIG. 2;

FIG. 6 is schematic block diagram illustrating interaction between elements in accordance with the present invention;

FIG. 7 is a flowchart illustrating a method of operation of a video processing system; and

FIG. 8 is a flowchart illustrating functions of seeking video rights and optionally purchasing video rights performed by the video processing system of FIG. 7 according to one embodiment of the present invention.

### DETAILED DESCRIPTION OF THE PREFERRED EMBODIMENTS

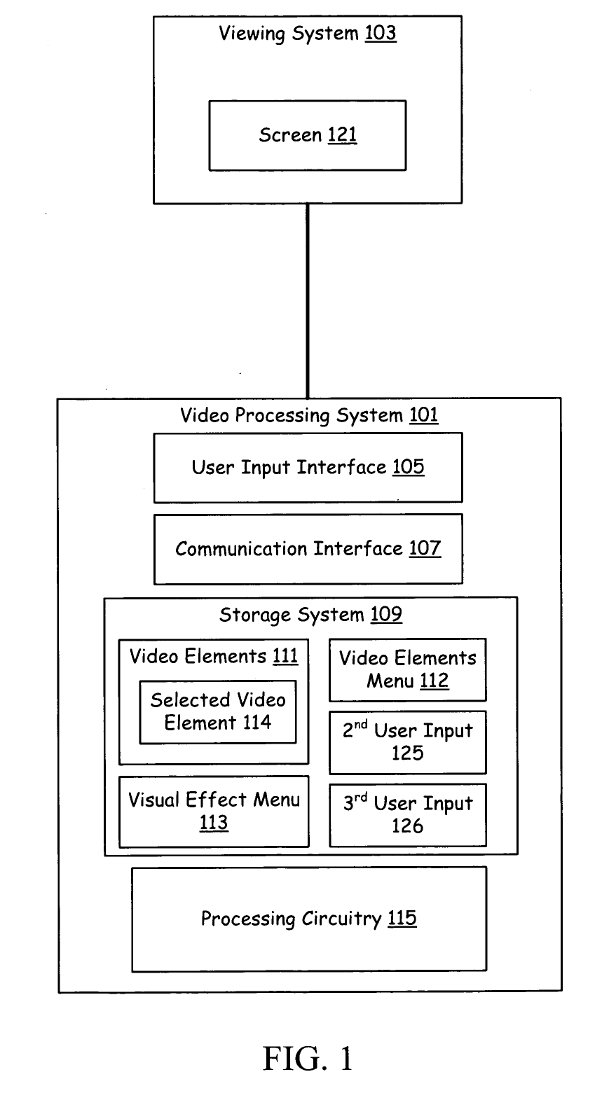

FIG. 1 is a schematic block diagram illustrating interaction between a video processing system 101 and a viewing system 103, the video processing system 101 generates a processed video by applying one or more visual effects to a selected portion of one of a plurality of video elements as per user input and delivers the processed video to the viewing system 103 in accordance with the present invention. The video processing system 101 and the viewing system 103 are located at the same premises. The video processing circuitry 101 includes a user input interface 105, a communication interface 107, a storage system 109 and a processing circuitry 115. The processing circuitry 115 is communicatively coupled to the user input interface 105, the communication interface 107 and the storage system 109. The viewing system 103 includes a screen 121, such as a TV screen, an LCD screen, etc., that can be used to display the processed video. The video processing system 101 and the viewing system 103 are communicatively coupled via one or more an infrared link, a cellular link, a wired link, a cable and an optical fiber link. Other communications links are also well-known in the art.

The video processing system 101 facilitates introducing special effects easily into video streams that may be pre-recorded or received in real-time. The video processing system 101 makes it possible to highlight specific portions of a video or digital image, create simple animations that can be incorporated into a video, and present the video in frames of different shapes, such as a heart shaped frame, a circular frame, a moving frame, a frame that moves like a rocket, a bouncing frame, etc. In another embodiment, the video processing system 101 is a toy that a child can operate to create special effects on digital images or on a live video captured via a digital camera or a digital video recorder.

The video processing system 101 facilitates tracking and subtraction of specific moving objects in a video. It facilitates identification of a display shape of a frame for the video by a viewer, such as a circular shape, and identification of a location for the shape on the display. The viewer can move the frame, size it and associate the video stream or image that will be displayed in the frame. It also facilitates specification of special effects, such as highlighting, movement, color modifications, etc. The video processing system 101 facilitates specification of a fixed region of interest, and a trackable region of interest in a video stream that will be displayed in the frame.

The storage system 109 stores a plurality of video elements 111 and a visual effect menu 113. The storage system 109 may be one of a magnetic tape, a digital video disc, a hard disc, and a rewritable memory. The storage system 109 is used to store configuration and details of special effects that can be implemented or enforced on portions of video data (video streams or video content) received from a remote video source. The storage system 109 provides a list of such special effects to the viewing system 103, if necessary, to permit a viewer to browse through available special effects and choose from them. Such special effects may be enabled or disabled by a viewer on specific portions or regions of interest in a media element or incoming video data.

The plurality of video elements 111, for example, may be one or more of a video part of a television channel program, an extract from a live video program, a video stream, a video game output, a stored video, and a picture. The user input interface 105 receives a viewer's selections on video effects to be implemented on specific video programs or video data received by the video processing system 101. For example, the user input identifies one of the plurality of video elements 114 as a target for special effects. In one embodiment, the user selects a video element as a target from a plurality of video elements 114, the selections is based on a video elements menu 112 or a browsable and selectable catalog of such video elements presented to the viewer. The video elements menu 112 includes a list of the plurality of video elements 111 stored in the storage system 109 or available from a video source that is remote or from a local video source, such as a DVD player.

In the one embodiment, the processing circuitry 115 retrieves the video elements menu 112 from the storage system 109 and forwards the video menu 112 to the viewing system 103 for display on the screen 121. Subsequently the user input interface 105 receives the viewer's selections as an input selection.

The communication interface 107 retrieves the selected one from the plurality of video elements 114 stored in the storage system 109 or communicated by a remote video source. A remote control or some such input device (for example, a pen, a touch sensitive screen, a mouse, etc.) is used by a viewer to make selections. The communication interface 107 sends the selected one of the plurality of video elements 114 to the viewing system 103 that displays it on the screen 121. The user input interface 105 can then receive an effects user input from the viewer via a remote control or some such input device. The effects user input identifies at least a portion of the one of the plurality of video elements for subjecting it to special effects.

In another embodiment of the invention, a viewer visually interacts with the screen 121 on which the viewer selected video elements 114 is displayed. The viewer feeds the effects user input using the user input interface 105. According to this embodiment, the user input interface 105 communicates via the communication interface 107 with the viewing system 103 to enable the selection of one or more portion of one or more video elements from the plurality of video elements available for display. The storage system 109 stores the effects user input 125, if necessary, for subsequent or repeated usage.

The communication interface 107 also retrieves the visual effect menu 113 from the storage system 109 and sends the visual effect menu to the viewing system 103 for display. The visual effect menu 113 identifies a plurality of visual effects. The user input interface 105 receives a third user input identifying at least one of the plurality of visual effects. The third user input is based on the visual effect menu 113. The storage system 109 stores the third user input 126. The processing circuitry 115 of the video processing system 101 applies the at least one of the plurality of visual effects corresponding to the third user input 126 to the at least a portion of the one of the plurality of video elements corresponding to the second user input 125 and generates a processed video element. The processing circuitry 115 delivers the processed video element to the viewing system 103 for display on the screen 121.

One of the plurality of visual effects, for example, when applied to a selected portion of the selected video element 114 causes a rotation of the selected portion of 114 by an angle, or an increase in brightness of the selected portion of 114, or a change in shape of the selected portion of 114, or a change in size of the selected portion of 114, or the selected portion of 114 to spin or the selected portion of 114 to move at a decelerated speed.

In one embodiment, the video elements comprise of one or more pre-identified regions of interests and special effects can be applied to these regions of interest (ROI) if the ROI indicates that they can be subjected to them. In another embodiment of the invention, each video element is accompanied by information indicating the availability of ROIs and the special effects they can be subjected to.

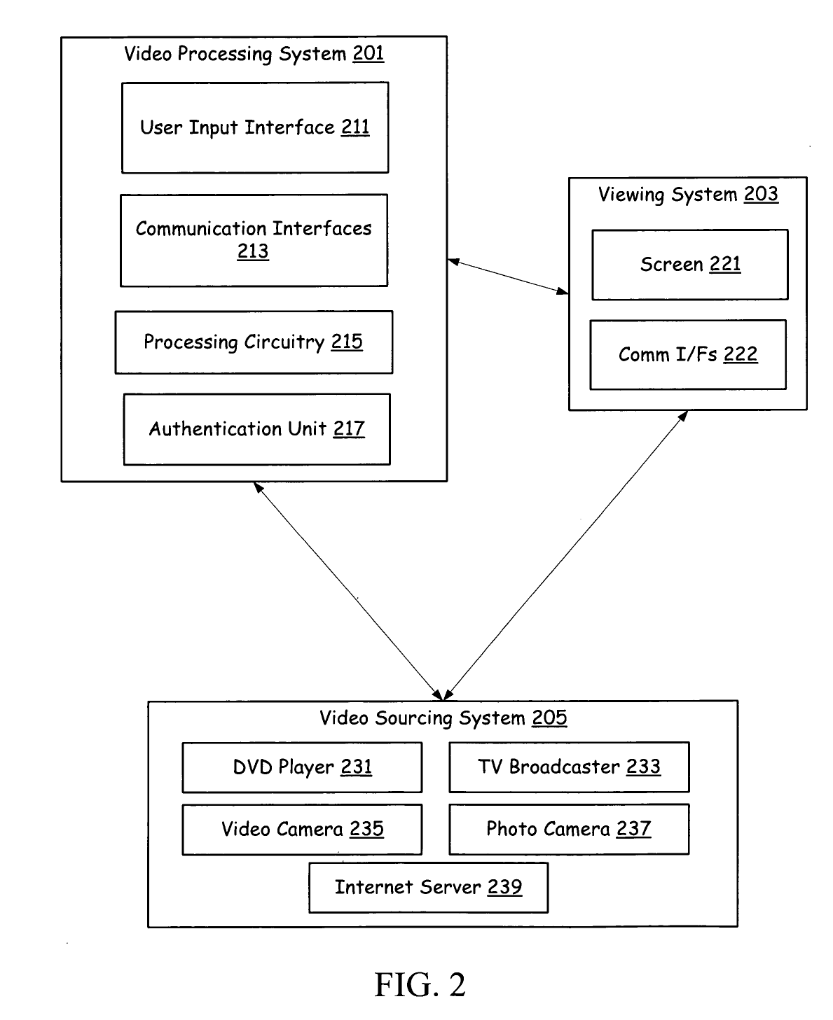

FIG. 2 is a schematic block diagram illustrating an interaction between a video processing system 201, a viewing system 203 and a video sourcing system 205. The video processing system 201 is communicatively coupled to the viewing system 203 and the video sourcing system 205 over one or more communication links, such as wireless links. For example, the wireless links may be one of an infrared link, a Bluetooth link, a radio frequency link, a microwave link, a satellite link, an 802.15 link, a cellular phone link and an 802.11 link. The video processing system 201 comprises a user input interface 211, a communication interface 213, a processing circuitry 215 and an authentication unit 217. The viewing system 213 includes a screen 221 and a communication interface 222. The video sourcing system 205 comprises at least one of a DVD player 231, a TV broadcaster 233, a video camera 235, a photo camera 237 and an Internet server 239. The processing circuitry 215 is communicatively coupled to the user input interface 211, the communication interface 213 and the authentication unit 217. The viewing system 203 is communicatively coupled to the video sourcing system 205. The DVD player 231, the TV broadcaster 233, the video camera 235, the photo camera 237 and the Internet server 239 have communication interfaces via which these communicate with the video processing system 201 and the viewing system 203.

The viewing system 203 receives a video stream from any one constituent of the video sourcing system 205. For example, the viewing system 203 receives the video streams from the television broadcaster 233 or some other local source. The viewing system 203 displays the video stream on the screen 221. The communication interface 213 of the video processing system 201 attempts to receive the video streams from the television broadcaster 233 (or the some other video source).

In another embodiment of the invention the video streams may not be a free and an access charge may be applied. The authentication unit 217 of the video processing system 201 seeks information on media rights from the television broadcaster 233 and also tries to authenticate the access by a viewer via the viewing system 203. The communication interface 213 receives the video streams from the television broadcaster 233 only if the video processing system 201 is authenticated by the television broadcaster 233 to receive the video streams (one or more video streams). In other embodiments of the invention the communication interface 213 receives the video stream from the viewing system 203 for storage or for communication to other systems.

If the video camera 235 provides the video element, such as the live video in real-time of the viewer or some other individual in proximity of the video camera 235, there are no charges typically for such content. In addition, the viewer, such as a child using a toy like embodiment of the present invention, will be able to capture the live video and display it in a frame (window) that is shaped to suit the viewer's preference, such as a heart shaped frame/window or a circular window that spins or takes off like a rocket, etc.

The user input interface 211 of the video processing system 201 receives a selection from a viewer that identifies an object (such as a region of interest that is associated with a moving car or a flower) from the video streams received. The object selected from the video stream is, for example, a tree, a butterfly, a house, an animal, a static object and a moving object. The selection may be based on a visual interaction of a user with the screen 221 on which the video stream is displayed. The selection may additionally be based on any other criterion.

For example, the object selected from the video stream may be the fastest moving object at a given time. The user input interface 211 also receives a motion selection. The processing circuitry 215 applies a motion corresponding to the motion selection to the object selected from the video stream thereby generating a processed video stream. As an example, the motion when applied to the selected object may cause the selected object from the video stream to move at an accelerated speed. The application of the motion may cause the selected object from the video stream to spin. It may cause the selected object from the video stream to tilt. The processing circuitry 215 sends the processed video stream to the viewing system 203 for displaying on the screen 221. The processed video stream retains characteristics of the video stream except the object selected from the video stream (e.g., the tree, or the butterfly, or the house, or the animal) moving at an accelerated speed or spinning or being in a tilted position.

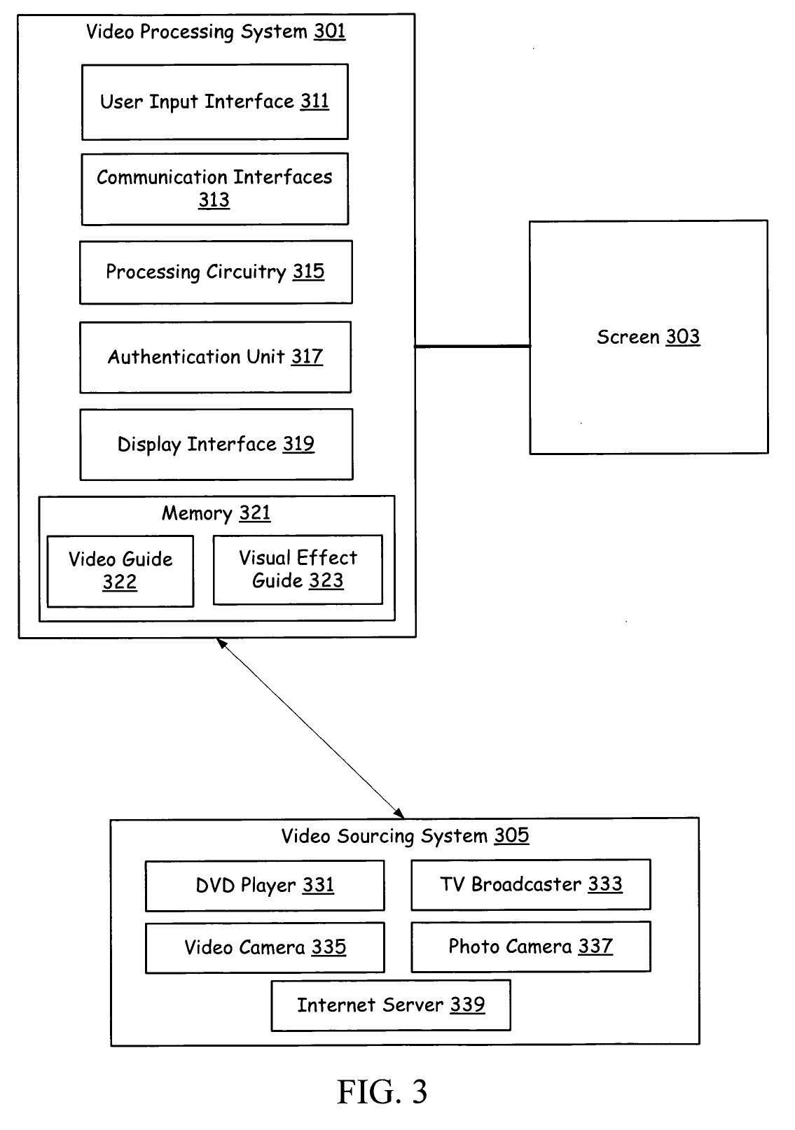

FIG. 3 is a schematic block diagram illustrating an embodiment of the video processing system 201 of FIG. 2 further providing a selection of the video stream from a video guide 322 and a selection of one or more visual effects from a visual effect guide 323. The video processing system 301 interacts with a screen 303 and a video sourcing system 305. The video processing system 301 is communicatively coupled to the screen 303 over a wired link and communicatively coupled to the video sourcing system 305 over a wireless link. The video processing system 301 includes a user input interface 311, a communication interfaces 313, a processing circuitry 315 and an authentication unit 317, a display interface 319 and a memory 321. The screen 303 may be for example, a television screen, a cellular phone screen or a computer screen.

The communication interface 313 of the video processing system 301 receives a video guide 322 from the video sourcing system 305 and stores it in the memory 321. The communication interface 313 forwards the video guide 322 to the screen 303 for display. The user input interface 311 receives a video selection based on the video guide 322, the selections may be made by a viewer or selected from a preconfigured selections. The video guide identifies the video streams available with the video sourcing system 305. For example, the video guide identifies a first set of video streams available with a television broadcaster 333, a second set of video streams available with the Internet server 339 and a third set of video streams available from the video camera 335. The user input interface may be provided using, for example, a pen, a touchpad, buttons and a mouse. A video element corresponding to the video selection is to be retrieved by the communication interface 313 from the video sourcing system. The video stream may typically be a movie, a video game, a television channel, a live video, and a personal video. All different types of video elements may be provided and some of them may not be free to use.

The television channel and the video game are typically ‘paid’ video elements. The authentication unit 317 of the video processing system 301 performs media rights management processing with the video sourcing system 305 for receiving a paid video stream. The communication interface 313 receives the paid video stream corresponding to the video selection from the video sourcing system 305 only after the video processing system 301 is successfully authenticated. The communication interface 313 forwards the video stream received from the video sourcing system 305 to the screen 303 via the display interface 319 for display.

The user input interface 311 of the video processing system 301 receives a selection that identifies an object from the video stream. The memory 311 of the video processing system 301 stores a visual effect guide 323. The visual effect guide 323 identifies a plurality of visual effects that can be generated and applied by the video processing system 301 to the object selected from the video stream. In some embodiments the user input interface 311 of the video processing system 301 comprises a plurality of keys corresponding to the plurality of visual effects. A selection of one of the plurality of keys prompts the processing circuitry 315 to apply the visual effect corresponding to the one of the plurality of keys to the object selected from the video stream. In another embodiment, the communication interface 313 forwards the visual effect guide 323 to the screen 303 for display. The user input interface 311 consequently receives a visual effect selection. The processing circuitry 315 applies a visual effect corresponding to the visual effect selection to the object selected from the video stream thereby generating a processed video stream. The visual effect when applied to the selected object may cause and without limitation, the selected object from the video stream to move at an accelerated speed, to spin, to fly, to take a different shape, to take a different size. The processing circuitry 315 delivers the processed video stream to the screen 303 for display.

For example, the object selected from the video stream may be a tree (not shown). The visual effect corresponding to the visual effect selection is a spinning effect. The processing circuitry 315 applies the spinning effect (visual effect) to the tree (selected object). The processed video stream retains characteristics of the video stream received from the video sourcing system 305 except the tree in the video stream replaced by a spinning tree in the processed video stream. As time elapses, the video stream received from the video sourcing system 305 may cease to display the tree (selected object). In another embodiment, the processing circuitry 315 ceases to apply the spinning effect (visual effect).

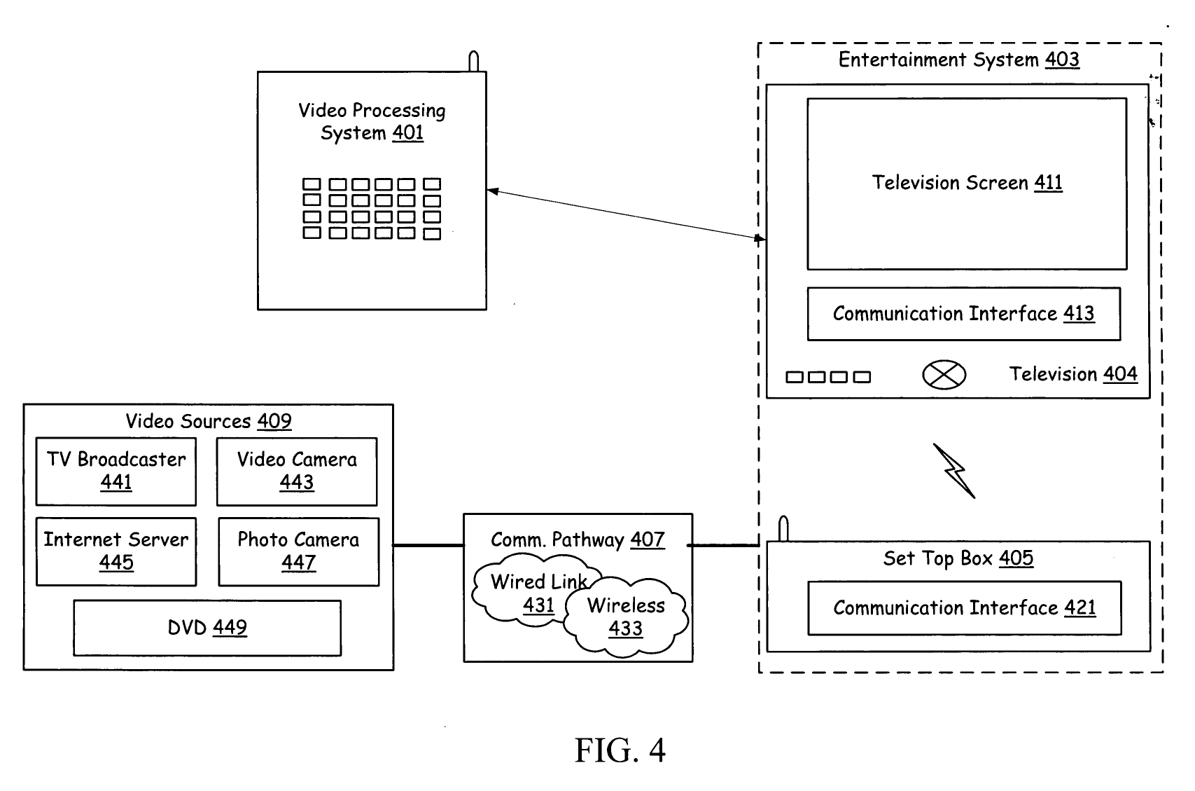

FIG. 4 is a schematic block diagram illustrating another embodiment of the video processing system 201 of FIG. 2 wherein the video processing system 401 interacts with a television screen 411 via a set-top-box 405. The video processing system 401 is communicatively coupled to the set-top-box 405 over a wireless link. The wireless link may comprise characteristics of any of a variety of communication link types e.g., Bluetooth, IEEE 802.11, IEEE 802.15, cellular telephony (e.g., GSM/GPRS/EDGE, CDMA, CDMA2000, UMTS, WCDMA, etc.), UltraWideBand, standard/proprietary, etc. The set top box 405 is part of an entertainment system 403. The entertainment system 403 also comprises a television 404. The television 404 is communicatively coupled to the set top box 405 via communication interface 413. The television 404 is communicatively coupled to one or more of the video sources 409 via the set top box 405. The set top box 405 transfers video elements between one or more of the video sources 409 and the television 404. The set top box is communicatively connected to the television 404 over at least a wireless and a wired link. Communication pathway 407 between the set top box 405 and the video sources 409 is one or more of, for example and without limitation, an infrared link, a radio frequency link, a microwave link, a Bluetooth link, an 802.11 link, a cable and an Ethernet link.

The television screen 411 of the television 404 displays a video element received by the set top box 405 from one of the video sources 409. The video element may be for example and without limitation, a video part of a television channel, a live snippet, a movie, a video part of a sporting or other entertainment event, a video stream, a video game, a stored video, or a picture. The video sources 409 comprise a television broadcaster 441, a video camera 443, an Internet server 445, a photo camera 447 and a DVD 449. The video processing system 401 receives the video element from the set top box 405. A user input interface of the video processing system 401 receives a first user input. The first user input identifies at least an object from the video element. The at least an object from the video element may be a figure.

The user input interface of the video processing system 401 may typically be a mouse and/or a layout of buttons. The user input interface (e.g., the mouse, the layout of buttons) communicates with television 404 via the set top box 405 for enabling selection of the at least an object from the video element. The video processing system 401 sends a visual effect menu to the set top box 405 and the set top box 405 sends the visual effect menu to the television 404 that displays the visual effect menu on the television screen 411. The visual effect menu comprises a list of plurality of video effects. The user input interface of the video processing system 401 receives a second user input. The second user input identifies a visual effect selected from the plurality of visual effects using the visual effect menu. The user input interface communicates with television 404 via the set top box 405 for enabling selection of the visual effect using the visual effects menu that is displayed on the television screen 411. In some embodiments, the visual effect may be selected from only some of the plurality of visual effects depending upon the at least an object from the video element identified by the first user input.

As an example, the plurality of visual effects comprises a tilting effect, a spinning effect and a speed increasing effect. If the at least an object identified by the first user input is a moving object, then the tilting effect and the speed increasing effect may be activated and not the spinning effect. In that case, the visual effect identified by the second user input is either the tilting effect or the speed increasing effect. The video processing system 401 applies the visual effect identified by the second user input to the at least an object identified by the first user input. For the above example, the visual effect when applied to the moving object either makes the moving object tilt or makes the moving object move at an increased speed. A new processed video element is thus generated. For the above example, the new processed video element retains all characteristics of the video element except the at least an object moves with a tilt or the at least an object moves at the increased speed. The video processing system 401 sends the processed video element to the set top box 405. The set top box 405 sends the processed video element to the television 404 for display on the television screen 411.

In another embodiment, the user input interface of the video processing system 401 receives a first user input that identifies a video selection. A video element corresponds to the video selection. The first user input may also identify one video source from the video sources 409. For example and without limitation, the first user input identifies a sports channel broadcast by the television broadcaster 441. The video processing system 401 triggers delivery of the video element (e.g., sports channel) from the television broadcaster 441 to the video processing system 401 and the television screen 411 via the set top box 405. The user input interface of the video processing system 401 subsequently receives a second user input that identifies at least a portion of the video element (e.g., sports channel) and a visual effect. For example, the at least a portion may refer to a right top quarter of the television screen 411 and the visual effect may be a brightness doubling effect. The video processing system 401 constructs a processed video element by applying the visual effect identified by the second user input to the at least a portion of the video element identified by the second user input. The video processing system 401 sends the processed video element to the set top box 405 that forwards the processed video element to the television screen 411 for display. In the above example, the video processing system 401 applies the brightness doubling effect to the sports channel displayed on the right top quarter of the television screen. The processed video element is the sports channel with the right top quarter of the sports channel revealed as twice brighter than rest of the sports channel.

In one embodiment, the video processing system 401 is incorporated into a set top box 405 that is communicatively coupled to the TV screen 411. The processed video with special effects created by the set-top-box 405 is displayed on the TV screen 411. The video source 409 may provide its own special effects and the viewer can either choose from them and/or create additional special effects (and save them optionally).

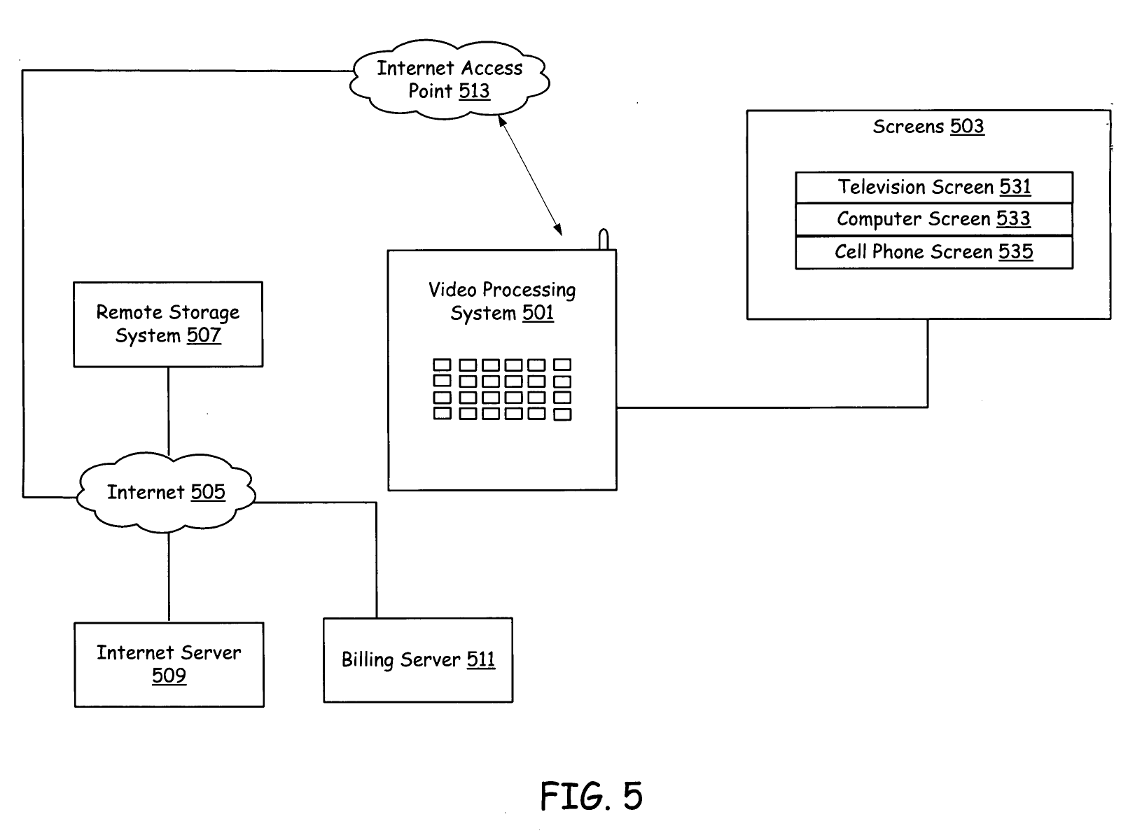

FIG. 5 is a schematic block diagram illustrating yet another embodiment of the video processing system 201 of FIG. 2 wherein the video processing system 501 receives a video element from an Internet server 509 and forwards the processed video element to one of screens 503 and a remote storage system 507 that is accessible via Internet 505. The screens 503 comprise a television screen 531, a computer screen 533 and a cell phone screen 535. The video processing system 501 is communicatively coupled to all of the screens 503 over one or more of a wired link, a wireless link and a cellular phone network. The video processing system 501 is communicatively connected to the Internet 505 through an Internet access point 513. The Internet server 509, the remote storage system 507, a billing server 511 and the video processing system 501 are communicatively coupled to each other via the Internet 505.

A user input interface of the video processing system 501 receives a user input that identifies a video selection. The user input interface of the video processing system 501 is one or more of, for example, a mouse, a touchpad, a thumbwheel, a pen, a layout of buttons and a voice based. A user may interact with the screens 503 visually. The user input interface of the video processing system 501 communicates with screens 503 to enable the video selection and any other selection. The user input interface in some other embodiment presents a plurality of options to the user so that the user input interface does not communicate with the screens 503 for the video selection and the any other selection.

The video processing system 501 retrieves a video element corresponding to the video selection from the Internet server 509 via the Internet access point 513. The video element is for example, and without limitation a picture, a movie. The video processing system 501 delivers the received video element (e.g., the picture, the movie) to the one of the screens 503 (e.g., the computer screen 533) for display. The user interacts with the one of the screens 503 (the computer screen 533) visually. The user input interface of the video processing system receives another user input identifying at least a portion of the video element and a visual effect. In some embodiments the visual effect identified by the another user input is based on a guide stored in the remote storage system 507. The video processing system 501 retrieves the guide from the remote storage system 507 and sends the guide to the one of the screens 503 (the computer screen 533) for display. The user input interface of the video processing system 503 subsequently receives the another user input.

The video processing system 501 constructs a processed video element from the video element (e.g., the picture, the movie) by applying the visual effect to the at least a portion of the video element. For example and without limitation, the video element is the picture, the at least a portion of the video element is a butterfly from the picture and the visual effect is a flying effect. The video processing system 501 applies the flying effect (the visual effect) to the butterfly from the picture (the at least a portion of the video element) and constructs the processed video element. The processed video element is a video that retains all characteristics of the picture except the butterfly that appears flying in the video. The video processing system sends the processed video element (the video with a flying butterfly) to the one of the screens 503 (the computer screen 533) for display. The video processing system 501 also forwards the processed video element to the remote storage system 507 for storage.

The video element (e.g., the picture, the movie) corresponding to the video selection is not always free to use. For example and without limitation, the video element is the movie. Before retrieving the video element (e.g., the movie) from the Internet server 509, the video processing system 501 purchases video rights for the video element (e.g., the movie) via interaction with the billing server 511. The billing server 511 authenticates the video processing system 501 and after successful authentication by the billing server 511, the Internet server 509 releases the video element (e.g., the movie) to the video processing system 501. Authentication may typically be a password based. The billing server 511 generates a monthly bill and the monthly bill is based on instances of the video element (e.g., the movie) being retrieved by the video processing system 501.

In another embodiment, purchasing of video rights for the video element, such as acquiring a DRM object) is supported. In still another embodiment, it is based on pre payment. The billing server 511 tracks and maintains a usage record for the video processing system 501 to stop the video processing system 501 from retrieving the video element more than a maximum number of times from the Internet server 509 and/or to stop the video processing system 501 from retrieving more than a maximum number of video elements from the Internet server 509.

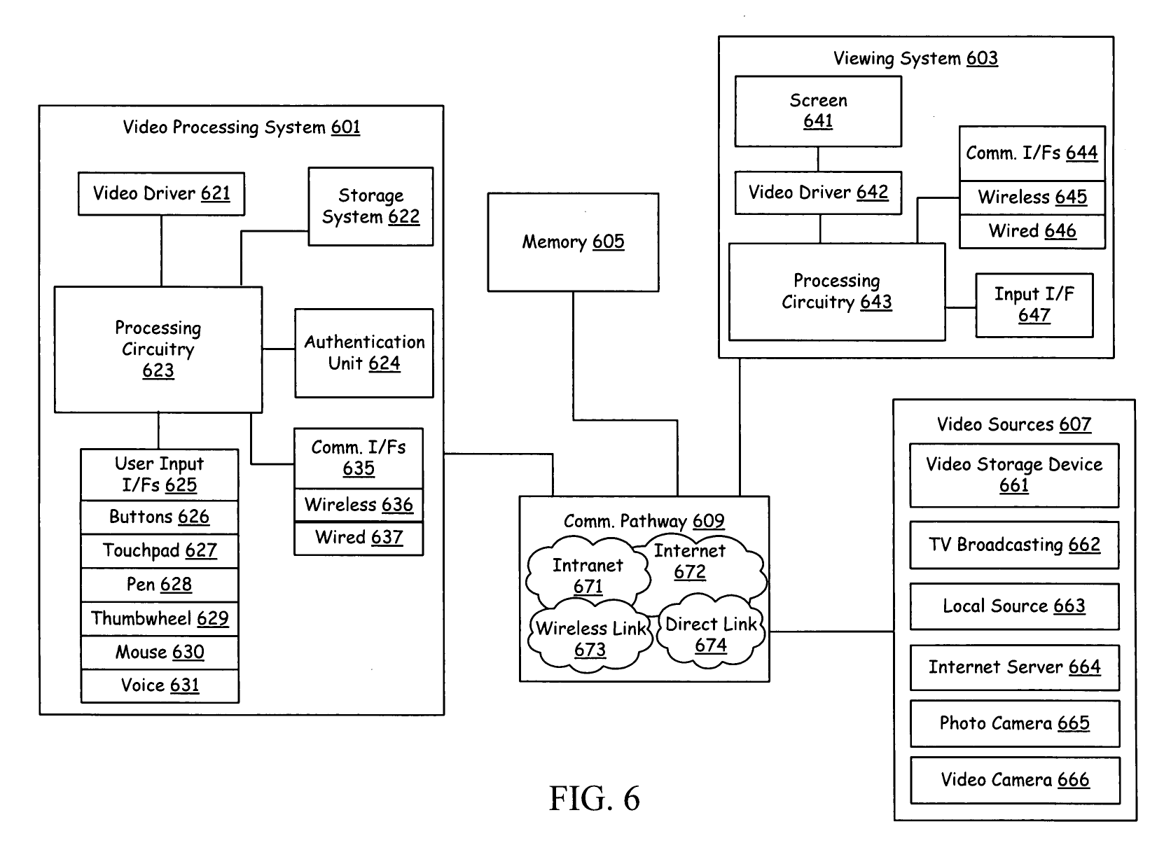

FIG. 6 is schematic block diagram illustrating interaction between a video processing system 601, a viewing system 603, video sources 607, a memory 605 and communication pathway 609 between these elements in accordance with the present invention. The video processing system 601 includes a video driver 621, a storage system 622, a processing circuitry 623, an authentication unit 624, a user input interface 625 and a communication interface 635. The viewing system 603 comprises a screen 641, a video driver 642, a processing circuitry 643, a communication interface 644 and an input interface 647. The video sources 607 includes a video storage device 661, a television broadcasting source 662, a local video source 663, an Internet server 664, a photo camera 665 and a video camera 666.

The user input interface 625 of the video processing system 601 supports selection of special effects and video elements via buttons 626, a touchpad 627, a pen interface 628 for a touch sensitive screen, a thumbwheel 629,a mouse 630 and a voice input mechanism 631. The user input interface 624 makes it possible for a viewer to employ one or more input devices (means) to enter their selections or to browse available choices of special effects and input sources. For example, the buttons 626 may be used by a viewer to start or stop the display, to advance forward or to reverse, etc. The touchpad 627 may be employed to enter the number of a special effect and associate it with a channel number that is keyed in using the touch pad. The pen 628 may be used to enter a name, search for saved special effects, etc. The thumbwheel 629 and the mouse 630 can be used to scroll down lists, navigate screens of information, etc. The voice based interface 631 makes it possible to provide input using voice commands and voice selections.

In some embodiments, the user input interface 625 includes a plurality of buttons where each of the plurality of buttons corresponds to only one of the plurality of video elements. The first user input identifies one of the plurality of buttons and hence consequently identifies a video element corresponding to the one of the plurality of buttons. The communication interface 635 retrieves the video element from the storage system 622 and sends the video element (e.g., a video, a movie, a picture) to the viewing system 603. The viewing system 603 displays the video element on the screen 641. The communication interface 635 retrieves the list that identifies a plurality of visual effects from the storage system 622 (e.g., a hard disc) and sends it to the viewing system 603 for display.

The user input interface 625 receives a second user input that identifies at least a portion from the video element (e.g., a video, a movie, a picture) and at least a visual effect selected from the plurality of visual effects using the list displayed on the screen 641. The at least a visual effect may be for example and without limitation, a spinning effect, a tilting effect, a reshaping effect and a resizing effect. The processing circuitry 623 of the video processing system 601 constructs a single customized video element by applying the at least a visual effect identified by the second user input to the at least a portion from the video element identified by second user input.

The communication pathway 609 is at least one or more of an Intranet 671, an Internet 672, a wireless link 673 and a direct link 674. For example, it could be an infra red interface for a remote control, a wired interface such as a firewire or a S-video interface to a video camera or a DVD player, etc.

The storage system 605 a flash memory, a magnetic tape, a hard disc, an optical disc and a digital video disc. The storage system 605 may also be a repository of a personal video recorder that is remotely hosted. The storage system 622 of the video processing system 601 has a plurality of video elements and a list that identifies a plurality of visual effects stored in it. The storage system 622 also stores a video guide information that comprises a list that identifies the plurality of video elements. The plurality of video elements is typically a video, a movie and a picture. The storage system 622 may be for example and without limitation a hard disc. The communication interface 635 of the video processing system 601 retrieves the video guide information from the storage system 622 and sends the video guide information to the viewing system 603 for display on the screen 641. The user input interface 625 of the video processing system 601 subsequently receives a first user input that identifies a video element from the plurality of video elements, i.e. a video source and the actual content being delivered for processing and incorporation of special effects.

An example of a video element may be a video showing a snail walking on grass. The second user input identifies two portions, a fist portion and a second portion from the video element (e.g., the video showing a snail walking on grass). The first portion is the snail and the second portion is a portion of the screen 641 displaying grass. The second user input identifies two visual effects, first visual effect and a second visual effect. The first visual effect is a size doubling effect and the second visual effect is a tilting effect. The processing circuitry 623 applies the first visual effect (e.g., the size doubling effect) to the first portion (e.g., the snail) and the second visual effect (e.g., the tilting effect) to the second portion (e.g., the portion of the screen 641 displaying grass). The single customized video element is an enlarged snail that is enlarged by two times walking on tilted grass. The communication interface 635 sends the single customized video element to the viewing system 603 for display on the screen 641. In another embodiment, the communication interface 635 sends the single customized video element to the memory 605 for storing.

In some embodiments, the user input interface 625 receives another user input that identifies a video storage request and one of the video sources 607. The communication interface 635 receives a video element from the one of the video sources 607 and stores the video element in the storage system 622.

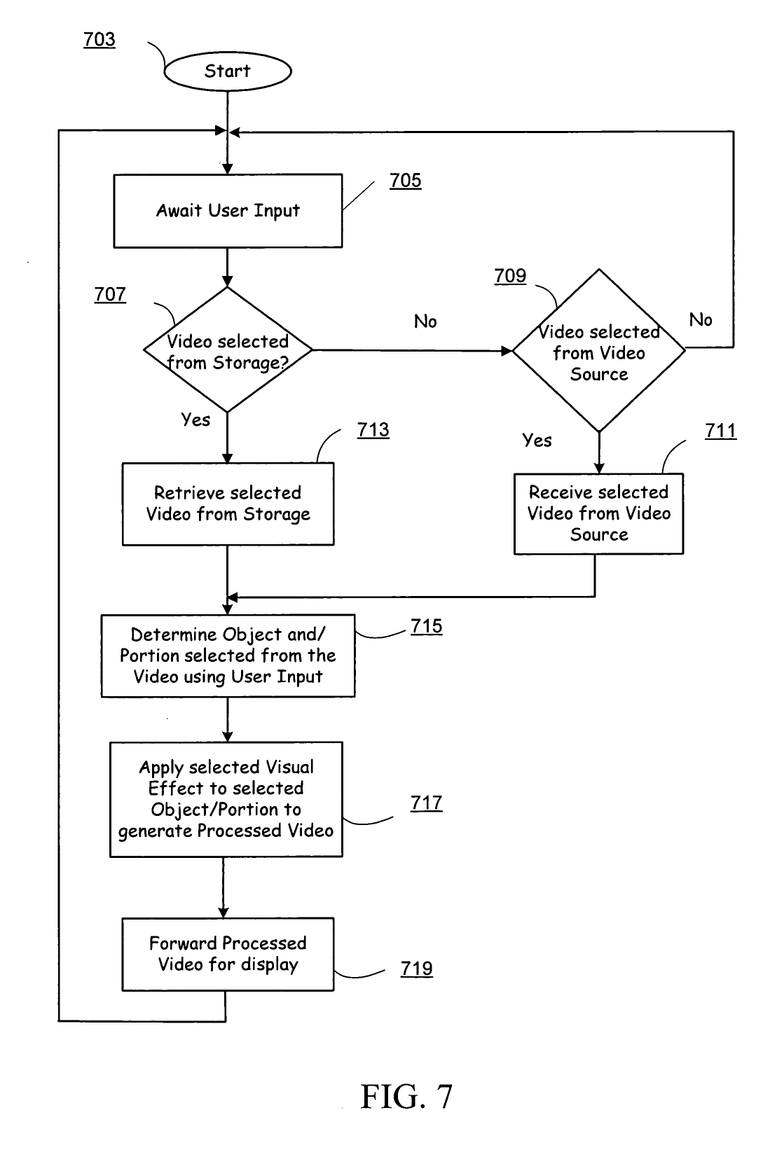

FIG. 7 is a flowchart illustrating a method of operation of a video processing system, as it responds to user input by generating a processed video element by applying visual effects to a selected video element, the user input provided through interaction with a screen on which the video element is displayed. The method starts at step 703. The video processing system awaits a user input as shown at step 705. The video processing system is communicatively coupled to a video source. The video processing system includes a storage system that stores a plurality of video elements. Video elements may be and without limit, video part of a television channel, a movie, a video game, a video stored in Internet server, a stored picture, a live video and a recorded video.

At step 707 the video processing system verifies if the user input has identified a video element stored in the storage system of the video processing system. If the video element identified by the user input is stored in the storage system, the video processing system retrieves the video element from the storage system at step 713. If the video identified by the user input is not stored in the storage system, then the video processing system tries to find out if the video element is available with the video source at step 709.

The video processing system may be communicatively coupled to a plurality of video sources. In one embodiment of the invention, the user input identifies one of the plurality of video sources where the video element is available. In another embodiment, the user input does not specify in which one of the plurality of video sources the video element is available. The video processing system searches for the video element in all of the plurality of video sources. If the video element is available with the video source, the video processing system receives the video from the video source at step 711. If the video is not available with the video source or any of the plurality of video sources, the video processing system awaits another user input as shown at step 705.

The video processing system determines a portion and or an object selected from the video element using the user input in step 715. A user selects the portion or the object from the video element. The user input in addition identifies a visual effect. The video processing system applies the visual effect identified by the user input to the selected portion and or to the selected object of the video at step 717, thereby generating a new processed video. At step 719, the video processing system forwards the processed video to the screen for display. The video processing system awaits another user input as shown at step 705.

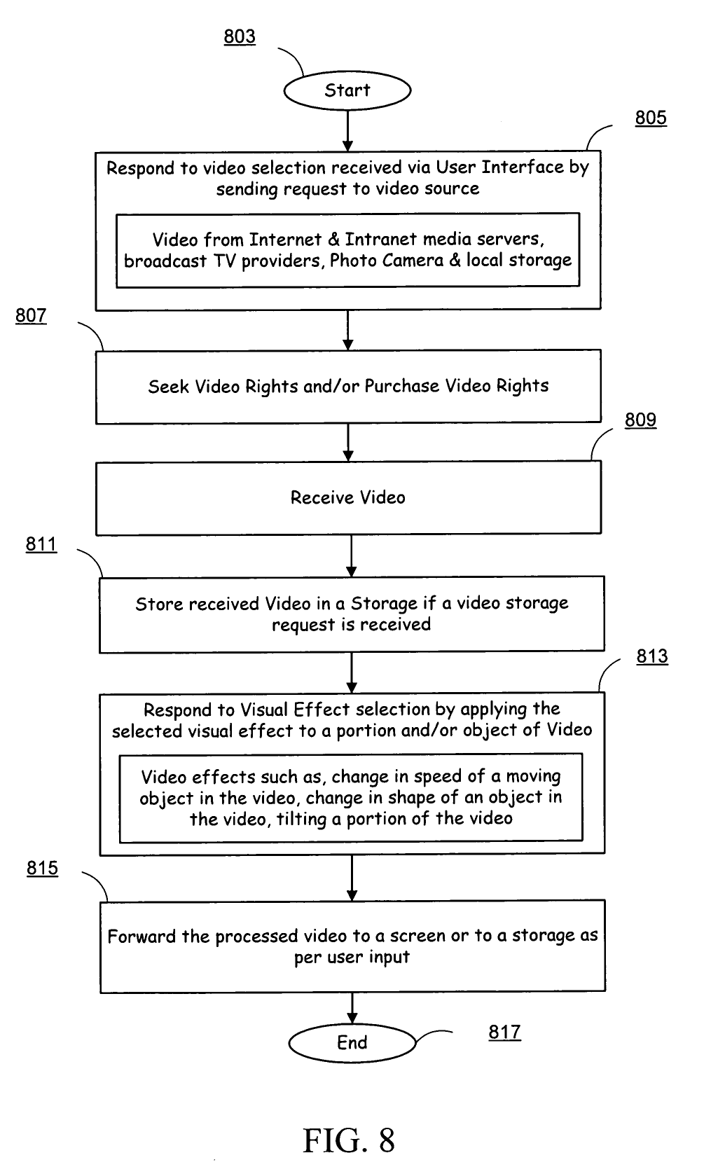

FIG. 8 is a flowchart illustrating functions of seeking video rights and optionally purchasing video rights performed by the video processing system of FIG. 7 according to one embodiment of the present invention. Processing starts at step 803. Then at a next block 805, the video processing system responds to a video selection received via a user input interface of the video processing system by sending request to a video source. A video element corresponding to the video selection is available in the video source. The video element may be, for example, a video part of a television channel, a movie, a video game, a video stored in Internet server, a stored picture, a live video and a recorded video. The video source may be, for example, a camcorder, a memory, an Internet server, an Intranet server, a television broadcaster, a DVD, and a photo camera. All of types of video elements are typically not free to view and/or free to use for further processing. In one embodiment the video element corresponding to the video selection is not free to use.

At the next step 807, if necessary, the video processing system seeks video rights for the video element from the video source. The video processing system purchases video rights for the video element, if necessary. Purchasing may be typically either online, or a pre-paid based or a post-paid based or a combination of these. In all types of purchasing, the video processing system is authenticated by the video source based on one or more inputs. The inputs may typically be a password and a personal identification number. An authentication unit communicatively coupled to the video source and the video processing system does authentication. A billing unit keeps track of video element usage and generates invoice based on the video element usage. The billing unit is communicatively coupled to the video source and the video processing system. One or more of the billing unit and the authentication unit may reside within the video source or within the video sourcing system. For the online purchasing at least, visual interaction with a screen is done. The video processing system receives the video element in step 809. The video element is displayed on a screen for further visual interaction. In some embodiments, the video processing system triggers display of the video element on the screen.

At step 811 the video processing system stores the video element in a storage system if the user input interface receives a video storage request. The video processing system receives a selection of at least a portion or at least an object of the video element and also receives a visual effect selection via the user input interface. At step 813 the video processing system applies a visual effect corresponding to the visual effect selection to the at least a selected portion or the at least a selected object of the video element to generate a processed video element. Then, at step 815 the video processing system forwards the processed video element to the screen for display and/or to a storage system for storing. Processing terminates at 817.

As one of average skill in the art will appreciate, the term “communicatively coupled”, as may be used herein, includes but is not limited to wireless and wired, direct coupling and indirect coupling via another component, element, circuit, or module. As one of average skill in the art will also appreciate, inferred coupling (i.e., where one element is coupled to another element by inference) includes wireless and wired, direct and indirect coupling between two elements in the same manner as “communicatively coupled”.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof. Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

We claim:

1. A video processing system that interacts with a viewing system having a screen, the screen displaying a video stream, the video processing system comprising:
a communication interface that receives the video stream;
a user input interface that receives a user input identifying an object from the video stream and a motion selection;
a processing circuitry that is communicatively coupled to the communication interface and the user input interface, the processing circuitry responds to the user input by generating a processed video stream from the video stream by applying a motion corresponding to the motion selection to the object from the video stream; and
the processing circuitry sending the processed video stream to the screen for display.

2. The video processing system of claim 1, wherein the video processing system is located at a first premises and the viewing system is located at a second premises.

3. The video processing system of claim 1, wherein the communication interface retrieves a list of a plurality of motions and the motion selection is based on the retrieved list.

4. The video processing system of claim 3, further comprising a storage system that stores the list of the plurality of motions.

5. The video processing system of claim 3, wherein the list of the plurality of motions includes a motion that, if applied to the object from the video stream, causes the object to spin.

6. The video processing system of claim 3, wherein the list of the plurality of motions comprises a motion that if applied to the object from the video stream causes the object move at an accelerated speed.

7. The video processing system of claim 1, wherein the communication interface receives the video stream from the viewing system.

8. The video processing system of claim 1, wherein the communication interface receives the video stream from a video sourcing system that sends the video stream to the viewing system.

9. A video processing system that interacts with a screen, the video processing system comprising:
a user input interface that receives a first user input identifying a video selection;
a communication interface that retrieves a video element that corresponds to the video selection;
a display interface via which the communication interface forwards the video element to the screen for display;
wherein the user input interface receives a second user input identifying at least a portion of the video element and a visual effect; and
a processing circuitry that responds to the second user input by constructing a processed video element by applying the visual effect to the at least a portion of the video element,
wherein the processing circuitry sends the processed video element to the screen via the display interface for display.

10. The video processing system of claim 9, wherein the communication interface receives a video guide information, and the video selection is based on the video guide information.

11. The video processing system of claim 9, wherein the processing circuitry delivers the processed video element to a storage system.

12. The video processing system of claim 11, further comprising the storage system.

13. The video processing system of claim 9, further comprising a memory that stores a plurality of video elements and the video element corresponding to the video selection is from the plurality of stored video elements.

14. The video processing system of claim 13, wherein the user input interface receives another user input identifying a video storage request, and the communication interface retrieves another video element corresponding to the video storage request and forwards the another video element to the memory for storage.

15. The video processing system of claim 9, further comprising an authentication unit that seeks permission to retrieve the video element by the communication interface.

16. The video processing system of claim 9, wherein the visual effect when applied to the at least a portion of the video element causes the at least a portion to turn by an angle.

17. A video processing system that interacts with a screen, the video processing system comprising:
a storage system that stores a plurality of a video elements and a visual effect menu that identifies a plurality of visual effects;
a user input interface that receives a first selection of one of the plurality of video elements;
a communication interface;
a display interface;
the user input interface receiving a second selection identifying at least a portion of the one of the plurality of video elements;
the user input interface receiving a third selection of at least one of the plurality of visual effects, the third selection is based on the visual effect menu;
a processing circuitry that constructs a processed video element by applying the at least one of the plurality of visual effects corresponding to the third selection to the at least a portion of the one of the plurality of video elements corresponding to the second selection; and
the processing circuitry sends the processed video element to the screen for display.

18. A method performed by a video processing system through interaction with a viewing system having a screen, the screen displaying a video stream, the method comprising:
receiving the video stream via a communication interface;
gathering a user input identifying an object from the video stream and a motion selection via a user input interface;
identifying the object from the video stream and the motion selection;
responding to the user input by generating a processed video stream from the video stream by applying a motion corresponding to the motion selection to the object from the video stream; and
sending the processed video stream to the screen for display.

19. The method of claim 18, further comprising retrieving a list of a plurality of motions via the communication interface wherein the motion selection is based on the list.

20. The method of claim 19, further comprising storing the list of the plurality of motions in a storage system.

21. The method of claim 18, wherein the video stream is received by the communication interface from the viewing system.

22. The method according to claim 18, wherein the video stream is received by the communication interface from a video sourcing system that sends the video stream to the viewing system.

23. The method according to claim 18, wherein the step of gathering comprises:
displaying to a user the video selection provided by the user;
showing a list of a plurality of special effects available for the video selection;
soliciting user selection of one or more of the special effects;
permitting the user to create an additional special effect while noting the user choice from the one or more of the special effects;
assembling a effects set based on the additional special effect and the user choice to aid in the construction of the processed video element from the video element selected by the user; and
storing the effects set.
